(19) United States
(12) Patent Application Publication
(10) Pub. No.: US 2026/0031607 A1
(43) Pub. Date: Jan. 29, 2026

(54) VEHICLE HAVING A HIGH-VOLTAGE ON-BOARD POWER SUPPLY AND METHOD FOR OPERATING THE HIGH-VOLTAGE ON-BOARD POWER SUPPLY

(71) Applicant: MERCEDES-BENZ GROUP AG, Stuttgart (DE)

(72) Inventors: Jörg WEIGOLD, Stuttgart (DE); Urs BOEHME, Ehningen (DE); Stefan SEIFFERT, Filderstadt (DE)

(21) Appl. No.: 18/996,384

(22) PCT Filed: Jul. 14, 2023
(86) PCT No.: PCT/EP2023/069732

§ 371 Date: Jan. 17, 2025

(30) Foreign Application Priority Data
Jul. 18, 2022 (DE) 10 2022 002 596.5

(51) Int. Cl. H02H 7/12; B60L 53/10; B60L 53/22; B60L 53/62

(52) U.S. Cl. CPC H02H 7/1213; B60L 53/11; B60L 53/22; B60L 53/62; B60L 2210/10

(57) ABSTRACT

A DC converter is arranged in one of the high-voltage potential lines of a vehicle having a high-voltage on-board power supply. A series connection of a varistor and a current measuring device is arranged between the other high-voltage potential line and the reference potential line. A processing unit switches off the DC converter if a current intensity measured by the current measuring device exceeds at least one predetermined limit value. Alternatively, a DC converter is arranged in each of the two high-voltage potential lines, and a series connection having a varistor and a current measuring device is arranged between each of the high-voltage potential lines and the reference potential line. A processing unit switches off the DC converters if a current intensity measured by at least one of the current measuring devices exceeds at least one predetermined limit value.

### BACKGROUND AND SUMMARY OF THE INVENTION

Exemplary embodiments of the invention relate to a vehicle having a high-voltage on-board power supply and a method for operating the high-voltage on-board power supply.

An energy coupler for electrically coupling electrical on-board power supplies and a method for electrically coupling electrical on-board power supplies are known from prior art, as described in DE 10 2017 009 352 A1. The energy coupler for electrically coupling a first electrical on-board power supply to which a first DC electrical voltage is applied to a second electrical on-board power supply to which a second DC electrical voltage is applied has a first and a second clocked energy converter, each of which has an on-board power supply connection and an intermediate circuit connection. The on-board power supply connection of the first clocked energy converter is connected to the first on-board power supply and the on-board power supply connection of the second clocked energy converter is connected to the second on-board power supply. The intermediate circuit connections of the first and second clocked energy converters are connected to a common DC intermediate circuit. A first electrical potential of the DC intermediate circuit is electrically connected to one of the electrical potentials of the first on-board power supply by means of the first clocked energy converter. A second electrical potential of the DC intermediate circuit is electrically connected to one of the electrical potentials of the second on-board power supply by means of the second clocked energy converter.

Exemplary embodiments of the invention are directed to a vehicle having a high-voltage on-board power supply that is improved in relation to the prior art, and an improved method for operating the high-voltage on-board power supply.

A vehicle has an electrical high-voltage on-board power supply. The term “high-voltage”, also abbreviated to HV, is in particular to be understood as an electrical DC voltage, which is in particular higher than 60V. The term “high-voltage” is in particular to be interpreted in accordance with the ECE R 100 standard.

The high-voltage on-board power supply has a traction battery, a charging connection for electrical coupling with a vehicle-external DC charging station, a high-voltage positive potential line, a high-voltage negative potential line, and a reference potential line. The traction battery is provided to supply electrical energy to at least one electric drive motor for driving the vehicle. The vehicle is therefore in particular an electric vehicle or a hybrid vehicle.

In an embodiment according to the invention, it is provided that a DC converter is arranged in one of the high-voltage potential lines and a series connection comprising a varistor and a current measuring device is arranged between the other high-voltage potential line and the reference potential line. Furthermore, in this embodiment according to the invention, a processing unit coupled to the current measuring device and the DC converter is provided, which is designed and set up to switch off the DC converter if a current intensity measured by the current measuring device exceeds at least one predetermined limit value.

In a method according to the invention for operating the high-voltage on-board power supply of the vehicle of this embodiment, it is accordingly provided that the current measuring device is analyzed by the processing unit and the DC converter is switched off if the current intensity measured by the current measuring device exceeds at least one predetermined limit value.

In an alternative embodiment according to the invention, it is provided that a DC converter is arranged in each of the two high-voltage potential lines and a series connection comprising a varistor and a current measuring device is arranged between each of the high-voltage potential lines and the reference potential line. Furthermore, in this alternative embodiment according to the invention, a processing unit coupled to the respective current measuring device and the DC converters is provided, which is designed and set up to switch off the DC converters if a current intensity measured by at least one of the current measuring devices exceeds at least one predetermined limit value.

In a method according to the invention for operating the high-voltage on-board power supply of the vehicle of this alternative embodiment, it is accordingly provided that the current measuring devices are analyzed by the processing unit and the DC converters are switched off if the current intensity measured by at least one of the current measuring devices exceeds at least one predetermined limit value.

By using the DC converter or the two DC converters, it is possible to charge the traction battery at a DC charging station with a charging voltage that is lower than the battery voltage of the traction battery, for example charging an 800V traction battery at a DC charging station with a charging voltage of 400V or 500V. The DC converter or the respective DC converter is designed in particular as a galvanically coupled DC converter. This is a cost-effective and space-saving solution. However, the problem is that if an insulation fault occurs in the vehicle, another insulation fault can occur in the opposite high-voltage potential on the part of the DC charging station as a direct consequence. Some DC charging station manufacturers install a varistor between the reference potential and the high-voltage positive potential or between the reference potential and the high-voltage negative potential in the DC charging station to protect the insulation. This varistor in the DC charging station has a clamping voltage of 500V to 550V, for example. If this varistor in the DC charging station trips or the insulation is destroyed, a short circuit is generated in the traction battery, which in the so-called CHAdeMO charging standard leads to the destruction of a ground potential line in a charging cable with which the vehicle is electrically coupled to the DC charging station, as this ground potential line is only very thin. The following limit values have now been defined: 100 mAs to protect the varistor in the DC charging station and 7000 As² to protect the ground potential line in the charging cable.

This problem is solved by the solution according to the invention, because if an insulation fault occurs in the high-voltage on-board power supply of the vehicle in the solution according to the invention, whereby the insulation on the part of the DC charging station could be exposed to an excessively high applied voltage, then the relevant varistor of the high-voltage on-board power supply of the vehicle initially switches to a low-impedance state. For this purpose, it is provided in particular that the varistor in the first embodiment of the invention mentioned above or the respective varistor in the alternative embodiment of the invention mentioned above is designed in such a way that it switches to the low-impedance state when a predetermined voltage, which is lower than a design voltage of, for example, 500V of the vehicle-external DC charging station, for whose electrical coupling the charging connection is designed, is exceeded. This predetermined voltage is therefore 450V, for example. It is therefore provided in particular that the varistor or the respective varistor has a corresponding characteristic curve. It therefore switches to the low-impedance state even before the design voltage of the DC charging station is exceeded.

By means of the current measurement of the relevant current measuring device, the resulting conductive path can be measured quickly and without interference. This measured current, i.e., its current intensity, is compared with the at least one predetermined limit value or with several predetermined limit values via the evaluation by means of the processing unit and, if necessary, i.e., if it is exceeded, the DC converter is or the DC converters are thus switched off very quickly, i.e., their function is stopped.

By way of example, it is provided that the processing unit is coupled to contactors of the traction battery and/or to an isolating element arranged in at least one of the high-voltage potential lines. It is then designed and set up to activate the contactors and/or the at least one isolating element for isolation if, in the first embodiment according to the invention mentioned above, the current intensity measured by the current measuring device or, in the alternative embodiment according to the invention mentioned above, the current intensity measured by at least one of the two current measuring devices exceeds the at least one predetermined limit value. Accordingly, it is provided in the method for operation, for example, that the processing unit activates the contactors and/or the at least one isolating element for isolation if, in the first embodiment according to the invention mentioned above, the current measured by the current measuring device or, in the alternative embodiment of the invention mentioned above, the current intensity measured by at least one of the two current measuring devices exceeds the at least one predetermined limit value. This also, i.e., in addition to the above-described switching off of the DC converter or DC converters, very quickly causes the traction battery to open its contactors and/or one or more isolating elements to be activated to interrupt the short-circuit current in order to rectify the short-circuit current. The isolating element or the respective isolating element is formed, for example, as a semiconductor switch, diode or explosive fuse, i.e., as a pyrotechnic isolating element, also known as a pyro fuse. As the current at this early stage with a low-impedance varistor still assumes low values compared to a short circuit of the traction battery via a conductive insulation short circuit in the DC charging station, the isolating element or elements and, for example, the contactors of the traction battery can be designed smaller, as no design for the short-circuit current is required.

The solution according to the invention thus enables rapid and interference-free detection of exceeding a defined shift of the high-voltage potentials in the high-voltage on-board power supply of the vehicle via the current measurement, thereby stopping the function of the DC converter or the DC converters at a very early stage. As a result, the varistor in the DC charging station or the insulation in the DC charging station is not overloaded by an overvoltage, as the voltage is limited by the varistor in the high-voltage on-board power supply to a value below the insulation design voltage. This also prevents the varistor in the DC charging station and the ground potential line of the charging cable from being damaged or destroyed by a high current, as the varistor in the high-voltage on-board power supply keeps the resulting traction battery short-circuit current within the vehicle. The solution according to the invention also prevents faulty charging interruptions as, unlike other solutions, fault-free detection is achieved. In addition, the lower tripping voltage of the varistor in the high-voltage on-board power supply means that the resulting fault can be recognized more quickly, whereby the resulting battery currents are still limited by the resistance of the varistor. This enables the use of smaller isolating elements and/or contactors for isolation, as no design for a high short-circuit current is required.

To summaries, in the event of an insulation fault, the solution described enables safety measures to be initiated quickly based on the evaluation of the current measurement and the comparison with one or more predefined limit values of the current strength via the low-impedance varistor, in particular an early switch-off of the DC converter or DC converters and, for example, an early opening of contactors and/or isolating elements even at low currents, resulting in the other advantages described.

Exemplary embodiments of the invention are described in more detail below with reference to a drawing.

### BRIEF DESCRIPTION OF THE SOLE DRAWING FIGURE

The sole drawing FIGURE schematically shows an embodiment of a high-voltage on-board power supply of a vehicle electrically connected to a DC charging station by means of a charging cable.

### DETAILED DESCRIPTION

The sole figure shows a schematic depiction of a high-voltage on-board power supply 3 of a vehicle 4 electrically connected to a DC charging station 2 by means of a charging cable 1.

The vehicle 4 is, in particular, an electric vehicle or a hybrid vehicle, i.e., it has at least one electric drive motor to drive it. The high-voltage on-board power supply 3 has a traction battery 5 to supply electrical energy to this at least one electric drive motor.

The high-voltage on-board power supply 3 also has a charging connection 6 for electrical coupling with the vehicle-external charging station 2. This occurs via the charging cable 1, which is electrically coupled to the DC charging station 2 and the charging connection 6 for this purpose.

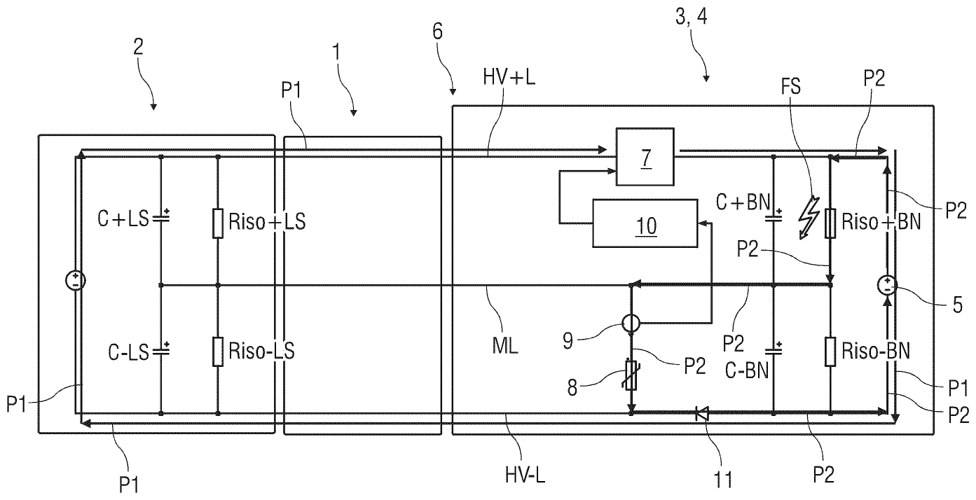

The high-voltage on-board power supply 3 also has a high-voltage positive potential line HV+L, a high-voltage negative potential line HV−L and a reference potential line ML, in particular a ground potential line. This also applies to the charging cable 1 and the DC charging station 2, as shown in FIG. 1.

Furthermore, an insulation resistor Riso+BN between the high-voltage positive potential line HV+L and the reference potential line ML, an insulation resistor Riso−BN between the high-voltage negative potential line HV−L and the reference potential line ML, a Y capacitor C+BN between the high-voltage positive potential line HV+L and the reference potential line ML and a Y capacitor C−BN between the high-voltage negative potential line HV−L and the reference potential line ML are provided in the high-voltage on-board power supply 3.

Also provided in the DC charging station 2 are, in particular, an insulation resistor Riso+LS between the high-voltage positive potential line HV+L and the reference potential line ML, an insulation resistor Riso−LS between the high-voltage negative potential line HV−L and the reference potential line ML, a Y capacitor C+LS between the high-voltage positive potential line HV+L and the reference potential line ML, and a Y capacitor C−LS between the high-voltage negative potential line HV−L and the reference potential line ML.

The high-voltage on-board power supply 3 is designed, in particular, to charge the traction battery 5 at a DC charging station 2 with a charging voltage that is lower than a battery voltage of the traction battery 5, for example charging an 800V traction battery at a DC charging station 2 with a charging voltage of 400V or 500V. By way of example, a traction battery 5 with a battery voltage of 800V is provided and the DC charging station 2 has a charging voltage of 500V, also referred to as the design voltage. To enable the traction battery 5 to be charged as described, the high-voltage on-board power supply 3 has a DC converter 7, which is arranged in the high-voltage positive potential line HV+L of the high-voltage on-board power supply 3 in the embodiment depicted. The DC converter 7 is designed as a galvanically coupled DC converter 7.

However, it is problematic that if an insulation fault occurs in the vehicle 4, another insulation fault can occur in the opposite high-voltage potential on the part of the DC charging station 2 as a direct consequence. Some DC charging station manufacturers install a varistor, not depicted here, between the reference potential and the high-voltage positive potential or between the reference potential and the high-voltage negative potential in the DC charging station 2 to protect the insulation. This varistor in the DC charging station 2 has a clamping voltage of 500V to 550V, for example. If this varistor in the DC charging station 2 trips or the insulation is destroyed, a short circuit of the traction battery 5 is generated, which in the so-called CHAdeMO charging standard leads to the destruction of a ground potential line, i.e., the reference potential line ML, in the charging cable 1, as this ground potential line is only very thin. The following limit values have now been defined: 100 mAs to protect the varistor in the DC charging station 2 and 7000 As² to protect the ground potential line in the charging cable 1.

In the sole figure, the current flow of the normal charging current during charging of the traction battery 5 is depicted by means of first arrows P1. Furthermore, the described fault case is depicted in the sole figure by means of a fault symbol FS. In the example depicted, the high-voltage positive potential and the reference potential are conductively connected due to the insulation fault in the vehicle 4, as depicted by the connecting line through the insulation resistance Riso+BN. The second arrows P2 show the resulting short-circuit current flowing in the high-voltage on-board power supply 3.

In order to solve the problem described, it is provided in the depicted embodiment that a series connection of a varistor 8 and a current measuring device 9 is arranged between the high-voltage negative potential line HV−L and the reference potential line ML.

In an alternative embodiment not depicted, the DC converter 7 is arranged in the high-voltage negative potential line HV−L of the high-voltage on-board power supply 3 and is also designed as a galvanically coupled DC converter 7. Accordingly, it is then provided that the series connection of the varistor 8 and the current measuring device 9 is arranged between the high-voltage positive potential line HV+L and the reference potential line ML. The corresponding fault case can be detected here, i.e., the high-voltage negative potential and the reference potential are conductively connected due to the insulation fault in the vehicle 4.

Both in the embodiment depicted and in the other embodiment not depicted, a processing unit 10 coupled to the current measuring device 9 and the DC converter 7 is also provided, which is designed and set up to switch off the DC converter 7 if a current intensity measured by the current measuring device 9 exceeds at least one predetermined limit value.

In a method for operating the high-voltage on-board power supply 3 of the vehicle 4, it is correspondingly provided that the current measuring device 9 is analyzed by the processing unit 10 and the DC converter 7 is switched off if the current intensity measured by the current measuring device 9 exceeds at least one predetermined limit value.

The problem described is solved by means of the described embodiments of the high-voltage on-board power supply 3 in that when the insulation fault occurs in the vehicle 4, whereby the insulation on the part of the DC charging station 2 could be exposed to a voltage that is too high, the varistor 8 of the high-voltage on-board power supply 3 of the vehicle 4 first switches to a low-impedance state. To ensure this, it is provided that the varistor 8 is designed in such a way that it switches to the low-impedance state when a predetermined voltage is exceeded, which is lower than the design voltage of, for example, 500V of the vehicle-external DC charging station 2. This predetermined voltage is therefore 450V, for example. It is therefore particularly intended that the varistor 8 has a corresponding characteristic curve. It therefore switches to the low-impedance state even before the design voltage of the DC charging station 2 is exceeded.

By means of the current measurement of the current measuring device 9, the resulting conductive path can be measured quickly and without interference. This measured current, i.e., its current intensity, is compared with the at least one predetermined limit value or with several predetermined limit values via the evaluation by means of the processing unit 10 and, if necessary, i.e., if it is exceeded, the DC converter 7 is thus switched off very quickly, i.e., its function is stopped.

In addition, it can, for example, be provided that the processing unit 10 is coupled to the contactors, not depicted here, of the traction battery 5 and/or to an isolating element 11 arranged in at least one of the high-voltage potential lines HV+L, HV−L of the high-voltage on-board power supply 3. It is then designed and set up to activate the contactors and/or the at least one isolating element 11 for isolation if the current intensity measured by the current measuring device 9 exceeds the at least one predetermined limit value. Accordingly, it is provided in the method for operation, for example, that the processing unit 10 activates the contactors and/or the at least one isolating element 11 for isolation when the current intensity measured by the current measuring device 9 exceeds the at least one predetermined limit value. Furthermore, i.e., in addition to the above-described switching off of the DC converter 7 to rectify the short-circuit current, this very quickly causes the traction battery 5 to open its contacts and/or one or more isolating elements 11 to be activated to interrupt the short-circuit current. The isolating element 11 or the respective isolating element 11 is designed as a diode, for example, as shown in the example depicted, or as a semiconductor switch or explosive fuse. As the current at this early stage with a low-impedance varistor 8 still assumes low values compared to a short circuit of the traction battery 5 via a conductive insulation short circuit in the DC charging station 2, the isolating element 11 or the isolating elements 11 and, for example, the contactors of the traction battery 5 can be designed smaller, as no design for the short-circuit current is required.

In a further embodiment not depicted, a DC converter 7 of the high-voltage on-board power supply 3 is arranged in the high-voltage positive potential line HV+L and in the high-voltage negative potential line HV−L, and is also designed as a galvanically coupled DC converter 7. Correspondingly, it is provided that a series connection consisting of a varistor 8 and a current measuring device 9 is arranged between each of the high-voltage potential lines HV+L, HV−L and the reference potential line ML. In this case, the fault can be detected if the high-voltage positive potential and the reference potential are conductively connected due to the insulation fault in the vehicle 4, and the fault can be detected if the high-voltage minus potential and the reference potential are conductively connected due to the insulation fault in the vehicle 4.

In this embodiment, a processing unit 10 coupled to the respective current measuring device 9 and the DC converters 7 is correspondingly provided, which is designed and set up to switch off the DC converters 7 if a current intensity measured by at least one of the current measuring devices 9 exceeds at least one predetermined limit value.

In a method for operating the high-voltage on-board power supply 3 of the vehicle 4, it is correspondingly provided that the current measuring devices 9 are analyzed by the processing unit 10 and the DC converters 7 are switched off if the current intensity measured by at least one of the current measuring devices 9 exceeds at least one predetermined limit value.

The problem described is also solved by means of this embodiment of the high-voltage on-board power supply 3 in that when the respective insulation fault occurs in the vehicle 4, whereby the insulation on the part of the DC charging station 2 could be exposed to a voltage that is too high, the relevant varistor 8 of the high-voltage on-board power supply 3 of the vehicle 4 first switches to a low-impedance state. For this purpose, this embodiment provides in particular that the respective varistor 8 is designed in such a way that it switches to the low-impedance state when a predetermined voltage is exceeded, which is lower than the design voltage of, for example, 500V of the vehicle-external DC charging station 2. This predetermined voltage is therefore 450V, for example. It is therefore particularly provided that the respective varistor 8 has a corresponding characteristic curve. It therefore switches to the low-impedance state even before the design voltage of the DC charging station 2 is exceeded. In this embodiment, the two varistors 8 are thus each designed in this way.

In this embodiment, the current measurement of the relevant current measuring device 9 can also be used to measure the resulting conductive path quickly and without interference. This measured current, i.e., its current intensity, is compared with the at least one predetermined limit value or with several predetermined limit values via the evaluation by means of the processing unit 10 and, if necessary, i.e., if it is exceeded, the DC converters 7 are thus switched off very quickly, i.e., their function is stopped.

In addition, this embodiment can also provide for the processing unit 10 to be coupled to contactors of the traction battery 5 and/or to an isolating element 11 arranged in at least one of the high-voltage potential lines HV+L, HV−L of the high-voltage on-board power supply 3. It is then designed and set up to activate the contactors and/or the at least one isolating element 11 for isolation if the current intensity measured by at least one of the two current measuring devices 9 exceeds the at least one predetermined limit value. Accordingly, the method of operation provides, for example, that the processing unit 10 activates the contacts and/or the at least one isolating element 11 for isolation if the current intensity measured by at least one of the two current measuring devices 9 exceeds the at least one predetermined limit value. Furthermore, i.e., in addition to switching off the DC converters 7 as described above, this very quickly causes the traction battery 5 to open its contactors and/or one or more isolating elements 11 to be activated to interrupt the short-circuit current in order to rectify the short-circuit current. The isolating element 11 or the respective isolating element 11 can also be designed here, for example, as a semiconductor switch, diode or explosive fuse. As the current at this early stage with a low-impedance varistor 8 still assumes low values compared to a short circuit of the traction battery 5 via a conductive insulation short circuit in the DC charging station 2, the isolating element 11 or the isolating elements 11 and, for example, the contactors of the traction battery 5 can be designed smaller, as no design for the short-circuit current is required.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### REFERENCE NUMERAL LIST

1 charging cable
2 DC charging station
3 high-voltage on-board power supply
4 vehicle
5 traction battery
6 charging connection
7 DC converter
8 varistor
9 current measuring device
10 processing unit
11 isolating element
C+BN Y capacitor high-voltage on-board power supply
C−BN Y capacitor high-voltage on-board power supply
C+LS Y capacitor charging station
C−LS Y capacitor charging station
FS fault symbol
HV+L high-voltage positive potential line
HV−L high-voltage negative potential line
ML reference potential line
P1 first arrow
P2 second arrow
Riso+BN insulation resistor high-voltage on-board power supply
Riso−BN insulation resistor high-voltage on-board power supply
Riso+LS insulation resistor charging station
Riso−LS insulation resistor charging station

1-7. (canceled)

8. A vehicle comprising:
a high-voltage on-board power supply, wherein the high-voltage on-board power supply comprises
a traction battery;
a charging connection configured to electrically couple to a vehicle-external DC charging station;
a high-voltage positive potential line;
a high-voltage negative potential line, and
a reference potential line,
wherein a DC converter is arranged in one of the positive and negative high-voltage potential lines, and a series connection comprising a varistor and a current measuring device is arranged between the other of the positive and negative high-voltage potential line and the reference potential line, wherein a processing unit, coupled to the current measuring device and the DC converter, is configured to switch off the DC converter such that the function of the DC converter is stopped when a current intensity measured by the current measuring device exceeds at least one predetermined limit value, or
wherein a DC converter is arranged in each of the positive and negative high-voltage potential lines, and a series connection comprising a varistor and a current measuring device is arranged between each of the positive and negative high-voltage potential lines and the reference potential line, wherein a processing unit, coupled to the respective current measuring device and the DC converters, is configured to switch off the DC converters such that the function of the DC converter is stopped when a current intensity measured by at least one of the current measuring devices exceeds at least one predetermined limit value.

9. The vehicle of claim 8, wherein the varistor or the respective varistor is configured that it switches to a low-impedance state when a predetermined voltage lower than a design voltage of the vehicle-external DC charging station for the electrical coupling of which the charging connection is designed is exceeded.

10. The vehicle of claim 8, wherein the DC converter or the respective DC converter is a galvanically coupled DC converter.

11. The vehicle of claim 8, wherein the processing unit is coupled to contactors of the traction battery or is coupled to an isolating element arranged in at least one of the positive and negative high-voltage potential lines and is configured to activate the contactors or the at least one isolating element for isolation when the current intensity measured by the current measuring device or by at least one of the two current measuring devices exceeds the at least one predetermined limit value.

12. The vehicle of claim 11, wherein the isolating element is a semiconductor switch, diode or explosive fuse.

13. A method for operating a high-voltage on-board power supply of a vehicle, wherein the high-voltage on-board power supply comprises a traction battery, a charging connection configured to electrically couple to a vehicle-external DC charging station, a high-voltage positive potential line, a high-voltage negative potential line, and a reference potential line, wherein a DC converter is arranged in one of the positive and negative high-voltage potential lines, and a series connection comprising a varistor and a current measuring device is arranged between the other of the positive and negative high-voltage potential line and the reference potential line, wherein a processing unit is coupled to the current measuring device and the DC converter, or wherein a DC converter is arranged in each of the positive and negative high-voltage potential lines, and a series connection comprising a varistor and a current measuring device is arranged between each of the positive and negative high-voltage potential lines and the reference potential line, wherein a processing unit is coupled to the respective current measuring device and the DC converters, the method comprising:
evaluating, by the processing unit, the current measuring device or the respective current measuring device; and
switching off the DC converter when the current intensity measured by the current measuring device exceeds at least one predetermined limit value or when the current intensity measured by at least one of the current measuring devices exceeds at least one predetermined limit value.

14. The method of claim 13, wherein the processing unit activates battery contactors or at least one isolating element for isolation when the current intensity measured by the current measuring device or by at least one of the two current measuring devices exceeds the at least one predetermined limit value.
